(19) United States
(12) Patent Application Publication
(10) Pub. No.: US 2007/0177145 A1
(43) Pub. Date: Aug. 2, 2007

(54) Optical spectrum analyzer

(75) Inventors: Kazushi Ohishi, Musashino-shi (JP); Hiroshi Ohta, Musashino-shi (JP); Yoshinobu Sugihara, Musashino-shi (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 11/698,047

(22) Filed: Jan. 26, 2007

(30) Foreign Application Priority Data
Jan. 27, 2006 (JP) 2006-018678

(51) Int. Cl. G01J 3/28

(52) U.S. Cl. 356/328

(57) ABSTRACT

An optical spectrum analyzer has a deflection section for changing an incidence angle of measured light on a diffraction grating, a plurality of light detection sections for detecting the dispersed measured light and outputting an electric signal responsive to the light strength, and a signal processing section for finding an optical spectrum of the measured light based on the electric signal from the light detection sections. The light detection sections are arranged along the wavelength dispersion direction of the diffraction grating and output electric signals independently of each other.

### TECHNICAL FIELD

The present disclosure relates to an optical spectrum analyzer, wherein a diffraction grating disperses measured light into a spectrum in response to the incidence angle on the diffraction grating, for measuring the measured light dispersed into a spectrum through the diffraction grating and finding the optical spectrum of the measured light. More particularly, the present disclosure relates to an optical spectrum analyzer capable of executing wavelength sweep at high speed and providing high wavelength resolution.

### RELATED ART

FIG. 7 is a drawing to show the configuration of an optical spectrum analyzer in a related art and shows an optical spectrum analyzer using a Czerny-Turner spectroscope as an example (For example, refer to patent document 1: Japanese Patent Unexamined Publication No. Hei. 8-101065). In FIG. 7, measured light containing various wavelengths is made incident through an incidence slit 1. A concave mirror 2 of a kind of collimator section converts the measured light passed through the incidence slit 1 into collimated light and emits the collimated light to a diffraction grating 3.

When the measured light is made incident on the diffraction grating 3 of a kind of wavelength dispersion element, the diffraction grating 3 disperses the measured light into a spectrum. Therefore, the emission light from the diffraction grating 3 (diffraction light) is propagated in a different direction for each wavelength and thus has a spatial spread and is made incident on a concave mirror 4. Further, the concave mirror 4 of a kind of light condensing section reflects the diffracted measured light and condenses the light at a different position on the plane of an exit slit 5 for each wavelength.

For example, measured light of wavelength λ1, that of wavelength λ2, and that of wavelength λ3 are condensed at positions P1 to P3 of the exit slit 5 respectively. Therefore, only the measured light of the wavelength component within the range of the breadth of the exit slit 5 (wavelength dispersion direction of the diffraction grating 3) in the condensed light (for example, wavelength λ2 at position P2) passes through the exit slit 5 and is detected at a photodetector 6, which then outputs an electric signal responsive to the light strength of the passed light. The photodetector 6 is a light detection section and is implemented using a single photodiode, for example.

Here, the incidence angle of the measured light on the diffraction grating 3 is changed, whereby the wavelength of light passing through the exit slit 5 also varies. For example, the diffraction grating 3 is rotated with a motor 7, whereby the incidence angle of the measured light on the diffraction grating 3 also changes and the positions at which the measured light of wavelength λ1, that of wavelength λ2, and that of wavelength λ3 are condensed on the plane of the exit slit 5 also change. The diffraction grating 3 is formed on a surface with a large number of grooves and is rotated on the axis parallel with the grooves. Consequently, the wavelength of light passing through the exit slit 5 changes and wavelength sweep is executed.

The motor 7 is rotated according to a control signal from a motor control section 8. A divider 9 divides the control signal from the motor control section 8 into two pieces and outputs one to the motor 7 and the other to a signal processing section 11. Further, an AD converter 10 converts the electric signal from the photodetector 6 into a digital signal with a sampling clock as the reference and outputs the digital signal to the signal processing section 11.

The signal processing section 11 finds the characteristics of the wavelength and the light strength, namely, an optical spectrum based on the digital signal output from the AD converter 10 using the control signal from the divider 9 as a trigger signal of the measurement start point, etc., and displays the optical spectrum on a display section 12.

Subsequently, FIG. 8 is a drawing to show the configuration of another optical spectrum analyzer in a related art. It shows an example wherein a linear image sensor with an array of photodiodes (light detection sections) is used in place of the photodiode 6 (For example, refer to patent document 2: Japanese Patent Unexamined Publication No. 2002-310796).

An optical fiber 13 is provided in place of the incidence slit 1 for propagating and emitting measured light. A collimator lens 14, which is a collimator section, is provided in place of the concave mirror 4 for converting the measured light from the optical fiber 13 into collimated light and emitting the collimated light.

A condensing lens 15, which is a light condensing section, is provided in place of the concave mirror 4 for condensing the measured light dispersed through a diffraction grating 3.

A photodiode array module (PDM) 16 is provided in place of the photodiode 6 and has photodiodes arranged on the light condensing face of the condensing lens 15. A read control section 18 is provided in place of the motor control section 8 and outputs a read clock signal through a divider 9 to the PDM 16 and a signal processing section 11. The motor 7 for rotating the exit slit 5 and the diffraction grating 3 is not required.

The PDM 16, which is an example of linear image sensor, has a one-dimensional array of photodiodes arranged at equal intervals on the same plane and reads outputs of the photodiodes in order and outputs a signal from a common terminal. The photodiodes form the light detection face and 256 to 512 photodiodes are arranged as a one-dimensional array by way of example. Measured light is dispersed into a spectrum in the arrangement direction of the photodiodes through the diffraction grating 3. The light detection width of the photodiodes in the arrangement direction thereof corresponds to the breadth of the exit slit 5. An amplifier 17 is provided between the PDM 16 and an AD converter 10.

The operation of such an apparatus is as follows:

The collimator lens 14 converts the measured light emitted from the optical fiber 13 into collimated light and emits the collimated light to the diffraction grating 3. The light is propagated (diffracted) in a different direction for each wavelength through the diffraction grating 3. Further, the condensing lens 15 condenses the diffraction light on the light detection face of the PDM 16; since the light condensing position varies depending on the wavelength, a spatial optical spectrum distribution of the measured light is formed on the light detection face.

The PDM 16 reads outputs of the photodiodes one at a time in order based on a read clock signal from the read control section 18 input through the divider 9 and outputs an electric signal via the common terminal to the amplifier 17, which then appropriately amplifies the signal from the PDM 16. The ADC 10 converts the analog signal into a digital signal and outputs the digital signal to the signal processing section 11.

The signal processing section 11 finds the characteristics of the wavelength and the light strength, namely, an optical spectrum based on the digital signal output from the AD converter 10 using the signal from the divider 9 as a trigger signal of the measurement start point, etc., and displays the optical spectrum on a display section 12.

For the apparatus for executing mechanical wavelength sweep using the motor 7 as shown in FIG. 7, time of about one second is required in a wavelength sweep span (also called wavelength sweep width) of 1000 [nm]. On the other hand, for the apparatus using the PDM 16 as shown in FIG. 8, no mechanical moving section exists and the PDM 16 reads outputs of the photodiodes in order with the read clock signal as the reference. Thus, as the read clock signal is more speeded up, the sweep time can be more shortened.

However, in a usual electric circuit, the limit of the frequency of a clock signal is about several [MHz] and the signals of the photodiodes are read in a cascade and therefore the read time per photodiode requires wait clock of about five to 10 clocks. This is the time required for the signal from the photodiode to become stable after electric switching of read of the photodiode in the PDM 16. This means that it is difficult to drastically shorten the wavelength sweep time even with the apparatus shown in FIG. 8; this is a problem.

In the apparatus shown in FIG. 7, the wavelength resolution is determined by the rotation angle of the motor and thus can be enhanced. In the apparatus shown in FIG. 8, however, the wavelength resolution is determined by the number of the photodiodes relative to the wavelength sweep width; for example, if 512 photodiodes are used, an optical spectrum can be divided only into 512 pieces with respect to the wavelength sweep width. This means that it is difficult for the apparatus shown in FIG. 8 to provide a high wavelength resolution; this is a problem.

### SUMMARY

Embodiments of the present invention provide an optical spectrum analyzer that can execute wavelength sweep at high speed and can provide a high wavelength resolution.

According to a first aspect of one or more embodiments of the invention, there is provided an optical spectrum analyzer for dispersing measured light into a spectrum through a diffraction grating and measuring the dispersed measured light to find an optical spectrum, the optical spectrum analyzer having:

a deflection section for changing an incidence angle of the measured light on the diffraction grating;

a plurality of light detection sections for detecting the dispersed measured light and outputting electric signals responsive to the light strength; and

a signal processing section for finding an optical spectrum of the measured light based on the electric signals from the light detection sections,

wherein the light detection sections are arranged along the wavelength dispersion direction of the diffraction grating and output electric signals independently of each other.

A second aspect of one or more embodiments of the invention is characterized by the fact that

in the first aspect of one or more embodiments of the invention, each of the light detection sections outputs the electric signal to the signal processing section via different wiring.

A third aspect of one or more embodiments of the invention is characterized by the fact that

in the first or second aspect of one or more embodiments of the invention, the plurality of light detection sections are a photodiode array formed on the same substrate.

A fourth aspect of one or more embodiments of the invention is characterized by the fact that

in the first aspect of one or more embodiments of the invention, the deflection section is any of an acousto-optic deflector, a polygon mirror, a galvanoscanner, or an MEMS mirror.

A fifth aspect of one or more embodiments of the invention is characterized by the fact that

in the first aspect of one or more embodiments of the invention, the optical spectrum analyzer is of double-path type for twice dispersing the measured light into a spectrum.

Various implementations may include one or more the following advantages. For example, the measured light dispersed into a spectrum through the diffraction grating is detected at the plurality of light detection sections and the light detection sections output the electric signals independently of each other to the signal processing section, so that the change amount of the incidence angle on the diffraction grating can be suppressed. Since the deflection section changes the incidence angle of the measured light on the diffraction grating, the wavelength resolution is not limited by the number of the light detection sections. Therefore, wavelength sweep can be executed at high speed and a high wavelength resolution can be provided.

Other features and advantages may be apparent from the following detailed description, the accompanying drawings and the claims.

### BRIEF DESCRIPTION OF THE DRAWINGS

In the accompanying drawings:

FIG. 1 is a drawing to show the configuration of a first embodiment of the invention;

FIG. 2A is a drawing to describe the operation of an AOD 20 when a radio frequency signal of the frequency f1 from the VCO 26 is applied;

FIG. 2B is a drawing to describe the operation of an AOD 20 when a radio frequency signal of the frequency f2 from the VCO 26 is applied;

FIG. 3 is a drawing to show an example of an optical spectrum provided by measuring measured light;

FIG. 4 is a drawing to show the configuration of a second embodiment of the invention;

FIG. 5 is a drawing to show the configuration of a third embodiment of the invention;

FIG. 6 is a drawing to show the configuration of a fourth embodiment of the invention;

FIG. 7 is a drawing to show the configuration of an optical spectrum analyzer in a related art; and

FIG. 8 is a drawing to show the configuration of another optical spectrum analyzer in a related art.

### DETAILED DESCRIPTION

Referring now to the accompanying drawings, there are shown preferred embodiments of the invention.

### FIRST EMBODIMENT

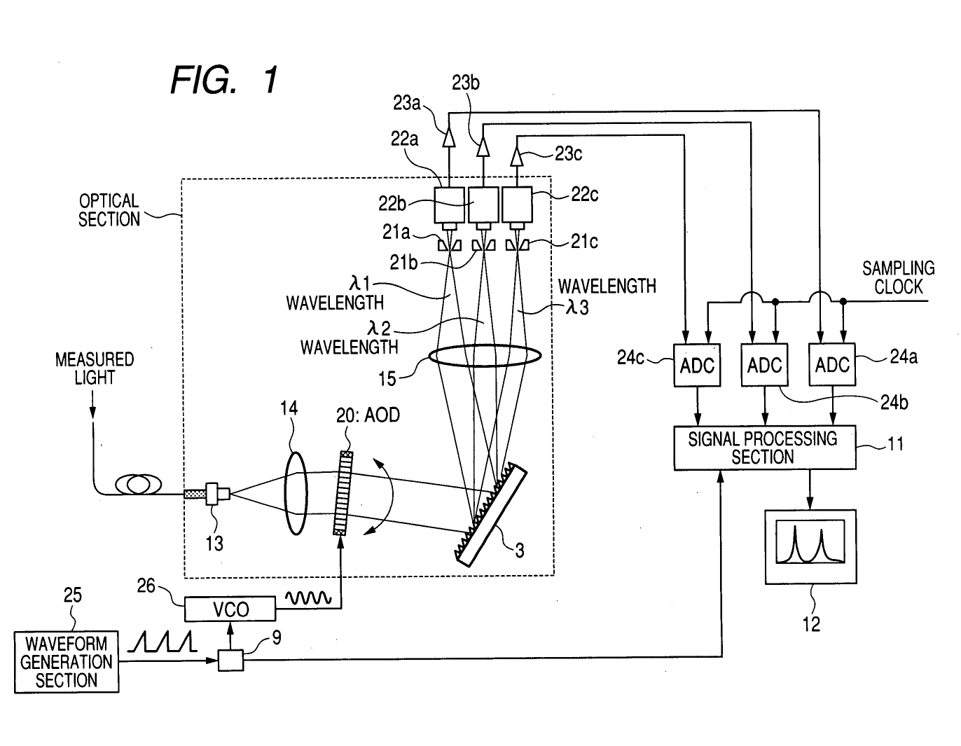

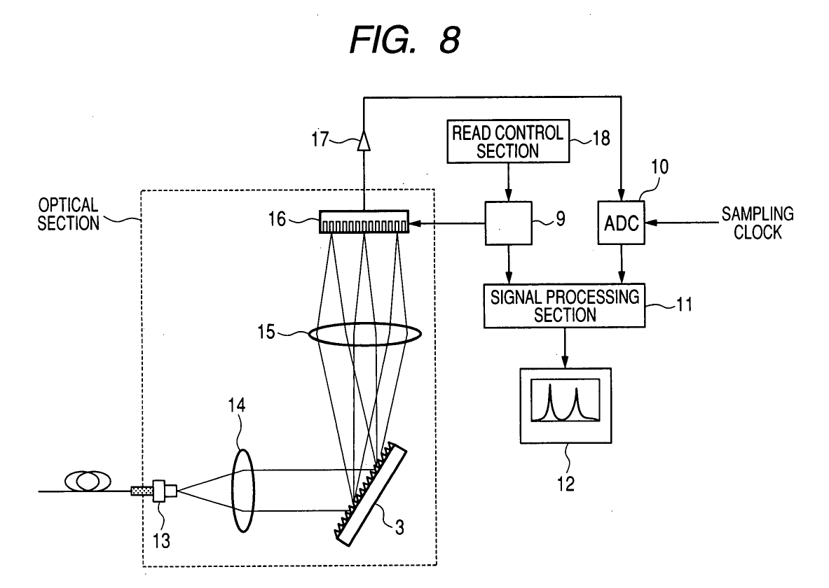

FIG. 1 is a drawing to show the configuration of a first embodiment of the invention. Components identical with those in FIG. 8 are denoted by the same reference numerals in FIG. 1 and will not be discussed again. In FIG. 1, an acousto-optic deflector (AOD) 20 is provided between a collimator lens 14 and a diffraction grating 3 for deflecting measured light of collimated light from the collimator lens 14 and changing the incidence angle of the measured light incident on the diffraction grating 3.

Exit slits 21a to 21c are arranged on the light condensing face as the focal position of a condensing lens 15. The exit slits 21a to 21c are placed along the direction in which the measured light is dispersed into a spectrum through the diffraction grating 3.

Light detectors 22a to 22c are provided in place of a PDM 16 for detecting the measured light passed through the exit slits 21a to 21c and outputting an electric signal corresponding to the detected light power. The light detectors 22a to 22c are light detection sections.

Amplifiers 23a to 23c appropriately amplify the signals from the light detectors 22a to 22c. AD converters 24a to 24c are provided in place of an AD converter 10 for converting analog signals from the amplifiers 23a to 23c into digital signals with the same sampling clock as the reference and outputting the digital signals to a signal processing section 11. Thus, the electric signals output from the light detection sections 22a to 22c are not combined at midpoint and are transmitted via different electric wiring to the signal processing section 11.

A waveform generation section 25 is used in place of a read control section 18 for generating any desired waveform, for example, a ramp wave. A divider 9 divides an electric signal from the waveform generation section 25 and executes frequency dividing as required. A voltage-controlled oscillator (VCO) 26 is a device with the frequency of an output radio frequency signal changing in response to the voltage value and outputs a radio frequency signal following the voltage of a ramp wave from the divider 9 to the AOD 20.

The signal processing section 11 finds the characteristics of the wavelength and the light strength, namely, an optical spectrum based on the digital signals output from the AD converters 24a to 24c using the signal from the divider 9 as a trigger signal of the measurement start point, etc., and displays the optical spectrum, etc., on a display section 12.

The operation of such an apparatus is as follows:

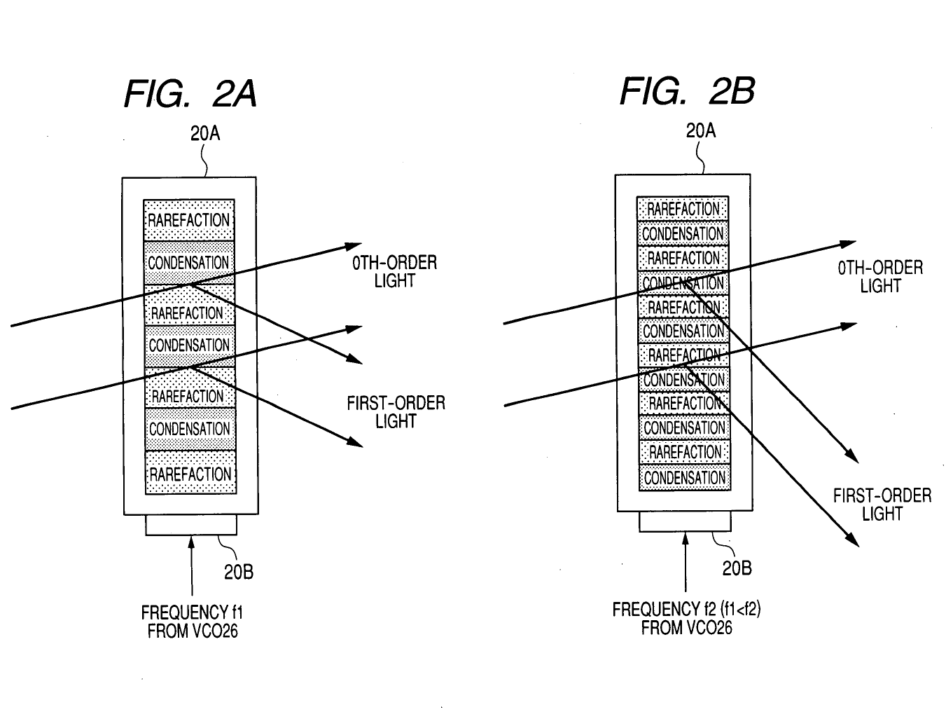

First, the operation of deflecting measured light by the AOD 20, namely, wavelength sweep of the measured light will be discussed. FIG. 2 is a drawing to show an example of the operation of the AOD 20. FIG. 2A shows the operation of the AOD when a radio frequency signal of the frequency f1 from the VCO 26 is applied. FIG. 2B shows the operation of the AOD when a radio frequency signal of the frequency f2 from the VCO 26 is applied.

The AOD 20 has a piezoelectric element 20B bonded to acoustooptic crystal 20A and when a radio frequency signal from the VCO 26 is applied, an ultrasonic wave is propagated through the crystal 20A, as shown in FIGS. 2A and 2B. At this time, the period of a compressional wave of refractive index propagated through the crystal 20A changes in response to the frequency of the radio frequency signal. The higher the frequency of the radio frequency signal, the shorter the period of compressional wave. Thus, the propagation angle of first-order diffraction light varies depending on the frequency of the radio frequency signal For example, making a comparison between the angular separation of Oth-order light and first-order light at frequency f1 and the angular separation of Oth-order light and first-order light at frequency f2, if frequency f1<f2, the angular separation at the frequency f2 is larger. of course, the first-order light is output to the diffraction grating 3.

The divider 9 divides the ramp wave from the waveform generation section 25 and outputs one to the VCO 26 and the other to the signal processing section 11. The signal output by the waveform generation section 25 is a waveform with the voltage value changing like a saw-tooth-wave with time, and a saw-tooth-wave is repeatedly output in a predetermined period.

Accordingly, the VCO 26 outputs a radio frequency signal whose frequency continuously changes following the voltage of the ramp wave to the AOD 20.

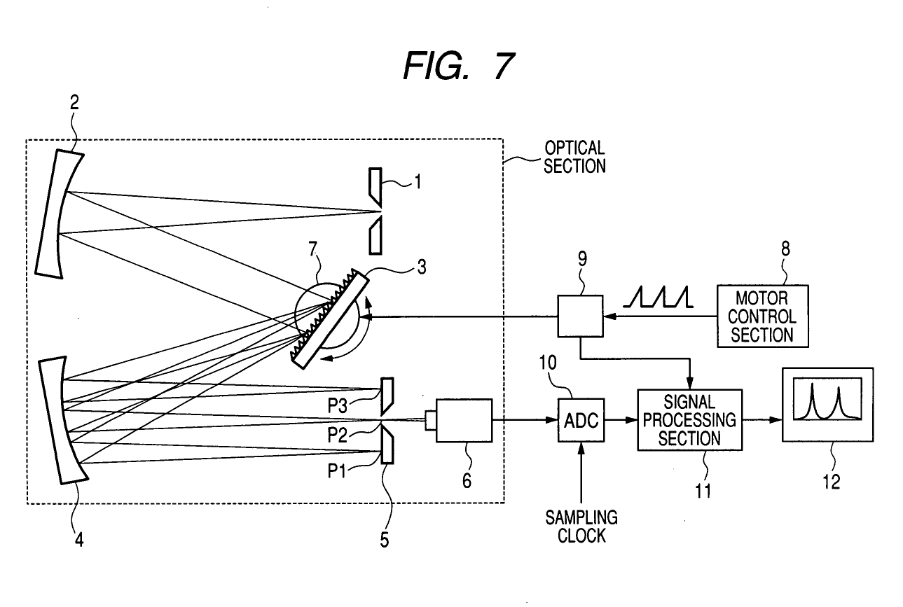

Therefore, the ramp wave is input to the VCO 26, a compressional wave responsive to the radio frequency signal from the VCO 26 is generated in the AO crystal 20A of the AOD 20, and the propagation direction of first-order light generated by the AOD 20 is deflected continuously. Therefore, the incidence angle of the first-order light on the diffraction grating 3 changes at high speed. That is, it is equivalent to rotating of the diffraction grating 3 for changing the incidence angle on the diffraction grating 3 as shown in FIG. 7 although the diffraction grating 3 is fixed. The deflection is repeated in response to the cycle period of the ramp wave.

Subsequently, the whole operation of the apparatus shown in FIG. 1 will be discussed.

Measured light is propagated through an optical fiber 13 and is emitted from a fiber end face of the optical fiber 13 to the collimator lens 14 at a predetermined emission angle. The collimator lens 14 converts the measured light into collimated light and emits the collimated light to the AOD 20.

On the other hand, in the AOD 20, a compressional wave responsive to a radio frequency signal from the VCO 26 is generated in the AO crystal 20A. Therefore, the AOD 20 changes the emission direction of the collimated light incident from the collimator lens 14 in response to the radio frequency signal, namely, deflects the measured light of the collimated light and emits the light to the diffraction grating 3.

The diffraction grating 3 disperses the measured light incident from the AOD 20 into a spectrum. Therefore, the emission light from the diffraction grating 3 is propagated in a different direction for each wavelength and thus has a spatial spread and is made incident on the condensing lens 15. Further, the condensing lens 15 condenses the measured light at different positions on the planes of the exit slits 21a to 21c for each wavelength. That is, a spatial optical spectrum distribution is formed on the light condensing face as the focal position. The optical spectrum distribution is repeatedly scanned over the planes of the exit slits 21a to 21c by dispersing the measured light into a spectrum through the diffraction grating 3 and deflecting the measured light by the AOD 20.

Only the measured light of the wavelength component within the range of the breadth of the exit slits 21a to 21c (width in the direction in which the diffraction grating 3 disperses the measured light into a spectrum) in the condensed light passes through the exit slits 21a to 21c and is detected at the light detectors 22a to 22c.

The light detectors 22a to 22c output electric signals responsive to the light strength of the passed light to the amplifiers 23a to 23c. Of course, the light detectors 22a to 22c output the electric signals independently of each other and thus may output the electric signals into which optical signals are converted to the following amplifiers 23a to 23c at the same time.

Further, the AD converters 24a to 24c convert the analog signals from the amplifiers 23a to 23c into digital signals and output the digital signals to the signal processing section 11. To execute wavelength sweep at high speed, the light detectors 22a to 22c implemented as photodiodes having response speed capable of responding to an impulse of the light passing through the exit slits 21a to 21c and the AD converters 24a to 24c having sampling speed capable of sampling the impulse are used.

The signal processing section 11 finds the characteristics of the wavelength and the light strength, namely, an optical spectrum based on the digital signals output from the AD converters 24a to 24c using the signal from the divider 9 as a trigger signal of the measurement start point, etc., and displays the optical spectrum, etc., on the display section 12. For example, the timing at which each wavelength of the measured light is detected varies and thus the time response of the light strength becomes optical spectrum information. Since deflection of the measured light, namely, the incidence angle on the diffraction grating 3 is determined uniquely from the voltage of the ramp wave, the signal processing section 11 converts the time information of the light strength into wavelength information from the voltage of the ramp wave.

Thus, the measured light dispersed into a spectrum through the diffraction grating 3 is detected at the light detectors 22a to 22c and the light detectors 22a to 22c output the electric signals provided by executing photo/electricity conversion independently of each other, so that the change amount of the incidence angle on the diffraction grating 3 can be suppressed as compared with the case where only one light detection section exists as shown in FIG. 7. This means that the deflection amount of the measured light by the AOD 20 can be lessened. Even if the deflection amount is small, it is made possible to measure an optical spectrum in a wide wavelength band.

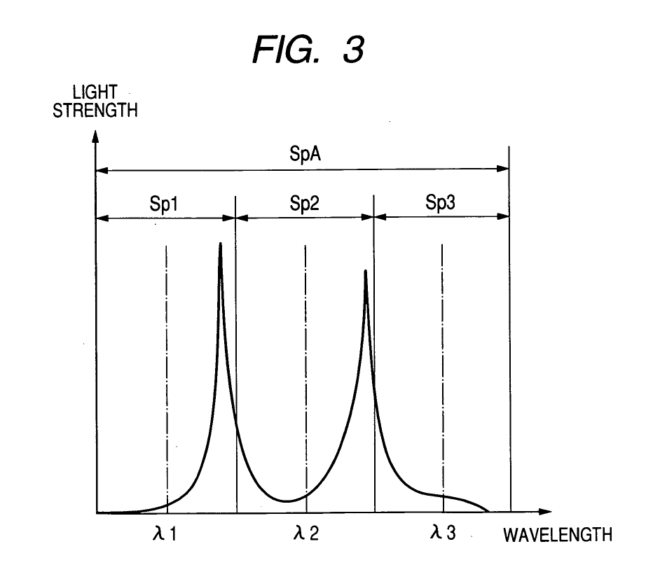

FIG. 3 is a drawing to show an example of an optical spectrum provided by measuring the measured light. In FIG. 3, the horizontal axis is the wavelength and the vertical axis is the light strength. Here, a sweep area Sp1 is a wavelength area detected in the light detector 22a, a sweep area Sp2 is a wavelength area detected in the light detector 22b, and a sweep area Sp3 is a wavelength area detected in the light detector 22c. Thus, wavelength sweep width SpA is divided into three pieces, the sweep areas Sp1 to Sp3 are measured separately, and the measurement results are combined by the signal processing section 11 to find an optical spectrum, so that wavelength sweep of the sweep areas Sp1 to Sp3 can be executed at the same time. Accordingly, wavelength sweep of the entire wavelength sweep width SpA can be executed at high speed. For example, the sweep time can be suppressed to ⅓ and the deflection amount can also be suppressed to ⅓ as compared with the case where only one light detector is used. Although the apparatus shown in FIG. 1 uses the three light detectors 22a to 22c, if n light detectors are used, the sweep time can be suppressed to 1/n and the deflection amount can also be suppressed to 1/n.

On the other hand, the wavelength resolution is limited by the number of the photodiodes of the PDM 16 in the apparatus shown in FIG. 8; the wavelength resolution is not limited by the number of the light detectors 22a to 22c in the apparatus shown in FIG. 1. Since the deflection amount of the AOD 20 is continuous, the wavelength resolution in the apparatus shown in FIG. 1 is determined by the light dispersion amount through the diffraction grating 3 and the light condensing degree on the planes of the exit slits 21a to 21c. Accordingly, a very high wavelength resolution can be provided.

Therefore, the apparatus shown in FIG. 1 can execute wavelength sweep at high speed and can provide a high wavelength resolution.

Further, if the deflection amount of the AOD 20 is lessened, the number of the light detectors 22a to 22c is increased, whereby the measurement wavelength range, namely, the wavelength sweep width can be widened. Accordingly, the effect of the deflection amount of the AOD 20 on the performance can be lightened. If the deflection amount is constant, a trade-off exists between the measurement wavelength range and the wavelength resolution; if the measurement wavelength range is narrowed, the wavelength resolution can be improved easily.

### SECOND EMBODIMENT

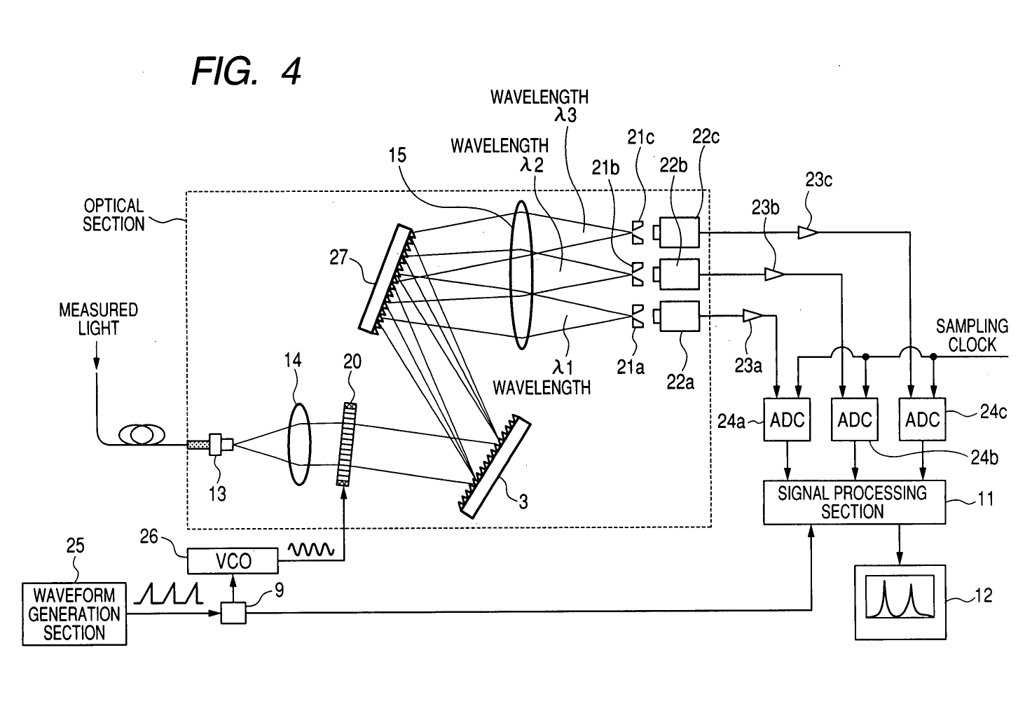

FIG. 4 is a drawing to show the configuration of a second embodiment of the invention. Components identical with those in FIG. 1 are denoted by the same reference numerals in FIG. 4 and will not be discussed again. FIG. 4 shows an example wherein the single-path structure of the optical section shown in FIG. 1 is changed to a double-path structure (additional dispersion placement). In FIG. 4, a diffraction grating 27 is provided between a diffraction grating 3 and a condensing lens 15. The diffraction grating 27 is placed at a position where it becomes additional dispersion placement with respect to the diffraction grating 3.

The operation of such an apparatus is as follows:

Measured light dispersed through the diffraction grating 3 is furthermore dispersed through the diffraction grating 27 and the light is emitted to a condensing lens 15. Other points of the operation are similar to those of the apparatus shown in FIG. 1 and therefore will not be discussed again.

Thus, the diffraction grating 27 as additional dispersion placement again disperses the measured light dispersed through the diffraction grating 3, so that the dispersion (spectral) angle increases and the wavelength resolution improves. For example, if a diffraction grating equivalent to the diffraction grating 3 is used as the diffraction grating 27, the wavelength resolution improves twice. Accordingly, the optical spectrum of the measured light can be measured with accuracy.

### THIRD EMBODIMENT

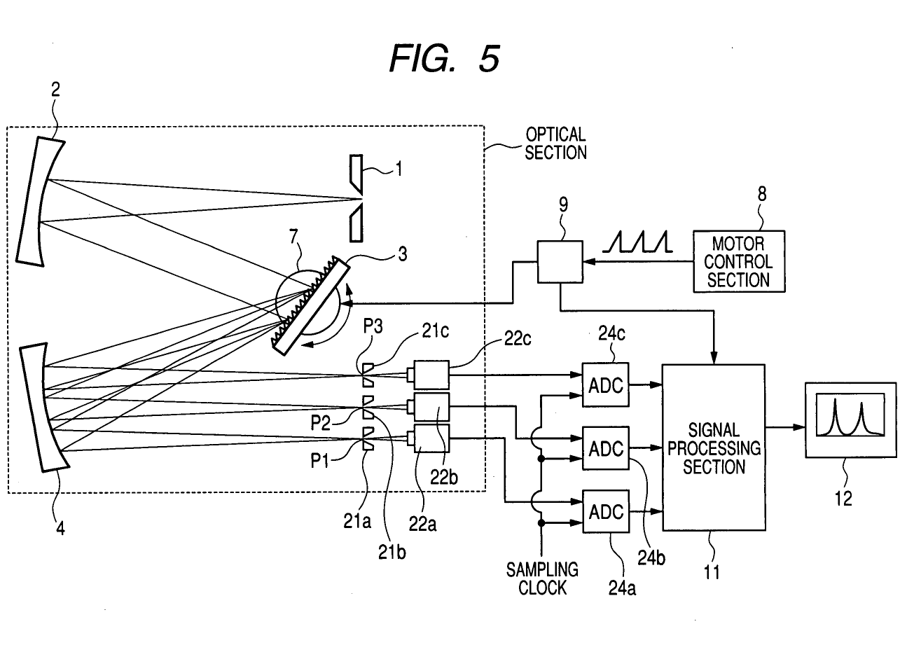

FIG. 5 is a drawing to show the configuration of a third embodiment of the invention. The invention is applied to the apparatus shown in FIG. 7. Components identical with those in FIGS. 1 and 7 are denoted by the same reference numerals in FIG. 5 and will not be discussed again. Exit slits 21a to 21c are provided on the light condensing face as the focal position of a concave mirror 4 in place of the exit slit 5. Light detectors 22a to 22c are provided in place of the photodetector 6. AD converters 24a to 24c are provided in place of the AD converter 10. Amplifiers 23a to 23c between the light detectors 22a to 22c and the AD converters 24a to 24c are not shown in the figure. A motor 7 corresponds to a deflection section.

The operation of such an apparatus is as follows:

Only the measured light of the wavelength component within the range of the breadth of the exit slits 21a to 21c (width in the wavelength dispersion direction) in the condensed light on the concave mirror 4 passes through the exit slits 21a to 21c and is detected at the light detectors 22a to 22c.

The light detectors 22a to 22c output electric signals responsive to the light strength of the passed light to the amplifiers 23a to 23c (not shown). Further, the AD converters 24a to 24c convert analog signals from the amplifiers 23a to 23c into digital signals and output the digital signals to a signal processing section 11.

The signal processing section 11 finds the characteristics of the wavelength and the light strength, namely, an optical spectrum based on the digital signals output from the AD converters 24a to 24c using the signal from a divider 9 as a trigger signal of the measurement start point, etc., and displays the optical spectrum, etc., on the display section 12. For example, the timing at which each wavelength of the measured light is detected varies and thus the time response of the light strength becomes optical spectrum information. Since deflection of the measured light, namely, the incidence angle on a diffraction grating 3 is determined uniquely from the voltage of the ramp wave, the signal processing section 11 converts the time information of the light strength into wavelength information from the voltage of the ramp wave. Other points of the operation are similar to those of the apparatus shown in FIG. 7 and therefore will not be discussed again.

Thus, the measured light dispersed into a spectrum through the diffraction grating 3 is detected at the light detectors 22a to 22c and the light detectors 22a to 22c output the electric signals provided by executing photo/electricity conversion independently of each other, so that the change amount of the incidence angle on the diffraction grating 3 can be suppressed if the rotation angle of the diffraction grating 3 is small as compared with the case where only one light detection portion exists as shown in FIG. 7. This means that the rotation amount of the diffraction grating 3 can be lessened. Even if the rotation amount is small, it is made possible to measure an optical spectrum in a wide wavelength band. Since the rotation amount can be suppressed, wavelength sweep can be executed at high speed and a high wavelength resolution equivalent to that of the apparatus shown in FIG. 7 can be provided.

The apparatus shown in FIG. 5 uses the simple single-path structure in the optical section by way of example, but may use a double-path structure for higher resolution.

### FOURTH EMBODIMENT

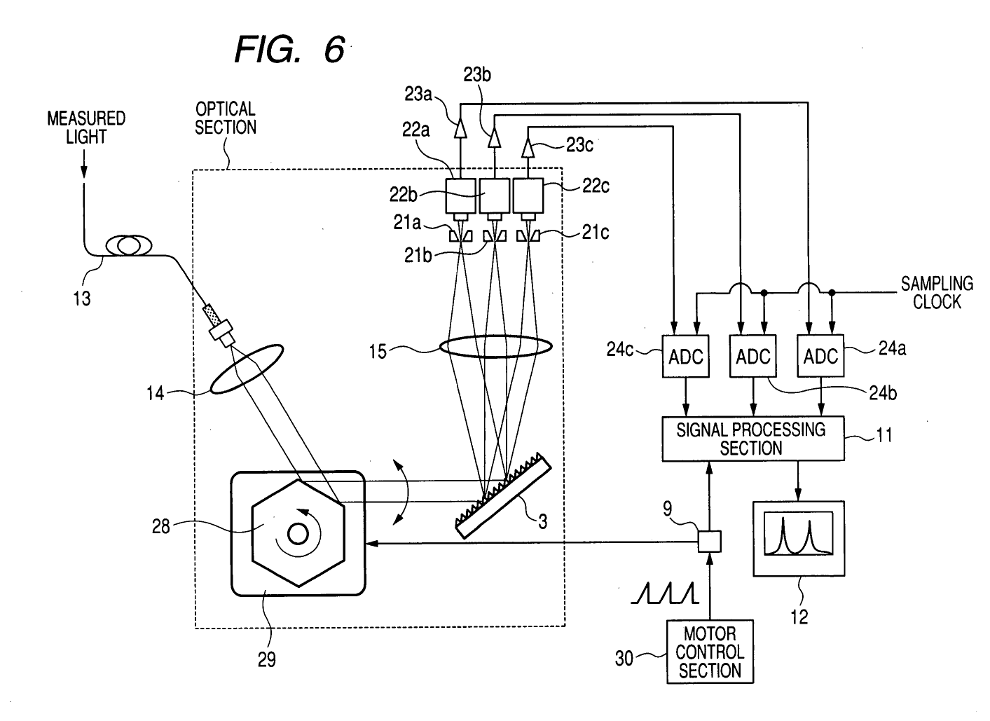

FIG. 6 is a drawing to show the configuration of a fourth embodiment of the invention wherein a polygon mirror is used as deflection section in place of the AOD 20 of the apparatus shown in FIG. 1 by way of example (for example, Japanese Patent Unexamined Publication No. Hei.11-132847). Components identical with those in FIG. 1 are denoted by the same reference numerals in FIG. 6 and will not be discussed again. In FIG. 6, a polygon mirror 28 is provided in place of the AOD 20 for deflecting measured light from a collimator lens 14 and emitting the light to a diffraction grating 3. A motor 29 and a motor control section 30 are provided in place of the VCO 26 and the waveform generation section 25. The motor control section 30 outputs a control signal for controlling rotation of the motor 29. The motor 29 rotates the polygon mirror 28 in a given direction at predetermined high speed based on the control signal.

The operation of such an apparatus is as follows:

The motor control section 30 outputs a control signal through a divider 9 to a signal processing section 11 and the motor 29. The motor 29 rotates the polygon mirror 28 at high speed. Accordingly, the measured light from the collimator lens 14 is deflected by the polygon mirror 28 and the incidence angle on the diffraction grating 3 changes and wavelength sweep is executed.

On the other hand, the signal processing section 11 finds the characteristics of the wavelength and the light strength, namely, an optical spectrum based on digital signals output from AD converters 24a to 24c using the signal from the divider 9 as a trigger signal of the measurement start point, etc., and displays the optical spectrum on a display section 12.

Other points of the operation are similar to those of the apparatus shown in FIG. 1 and therefore will not be discussed again. Although the wavelength sweep speed is not higher than that of the AOD 20, wavelength sweep of several [kHz] order can be executed.

The invention is not limited to the embodiments described above and may be as follows:

The apparatus shown in FIG. 6 uses the polygon mirror 28 as the deflection section in place of the AOD 20, but any of various light deflectors of a galvanoscanner, an MEMS (Micro Electro Mechanical Systems) mirror, etc., maybe used to deflect the measured light from the collimator section for changing the incidence angle on the diffraction grating 3.

In the apparatus shown in FIGS. 1 and 4 to 6, the light detectors 22a to 22c of light detection sections are provided separately, but photodiodes of light detection sections may be used as a photodiode array made up of photodiodes formed on the same substrate. A photodiode array module (PDM) may detect measured light. For example, the PDM has n photodiodes (n is two or more) and the photodiodes can be read separately rather than in a cascade and, of course, output terminals of the PDM are provided in a one-to-one correspondence with the photodiodes for transmitting electric signals from the photodiodes from the terminals to the signal processing section 11 via different wiring.

Exit slits 21a to 21c provided at the stage preceding the photodiodes have each a slit width opened in almost the same size as the condensed light beam size through the condensing lens 15 for selecting a wavelength. If the width of each photodiode (width in the wavelength dispersion direction) is equal to the condensed light beam size or so, the exit slits 21a to 21c may be eliminated. That is, the photodiodes function as the exit slits 21a to 21c. Of course, the photodiodes are arranged along the wavelength dispersion direction on the light condensing face of the focal position of the condensing lens 15.

Thus, the measured light dispersed into a spectrum through the diffraction grating 3 is detected at the photodiodes making up the photodiode array and the photodiodes output the electric signals provided by executing photo/electricity conversion independently of each other and therefore as many AD converters as the number of the photodiodes become necessary. However, since data of information of the optical spectrum of the detected light is not read in a cascade unlike the apparatus shown in FIG. 8, the extra time of wait clocks is eliminated and speeding up can be realized. Since the AOD 20 responds up to about sweep frequency 100 [kHz], if a photodiode array at sufficiently high response speed is used, wavelength sweep can be speeded up 100 to 1000 times that of the apparatus shown in FIG. 8. As described above, since the wavelength resolution is not limited by the number of the photodiodes, a high wavelength resolution can be provided. Therefore, wavelength sweep can be executed at high speed and a high wavelength resolution can be provided.

In the apparatus shown in FIGS. 1, 4, and 6, the measured light is emitted from the optical fiber 13 to the collimator lens 14, but the incidence slit 1 may be used as shown in FIG. 5; whereas, the optical fiber 13 may be used in place of the incidence slit 1 in the apparatus shown in FIG. 5. Alternatively, the optical fiber 13 and the incidence slit 1 may be used in combination to allow emission light from the optical fiber 13 to pass through the incidence slit 1.

What is claimed is:

1. An optical spectrum analyzer for dispersing measured light into a spectrum through a diffraction grating and measuring the dispersed measured light to find an optical spectrum, said optical spectrum analyzer comprising:
a deflection section for changing an incidence angle of the measured light on the diffraction grating;
a plurality of light detection sections for detecting the dispersed measured light and outputting electric signals responsive to the light strength; and
a signal processing section for finding an optical spectrum of the measured light based on the electric signals from said light detection sections,
wherein said light detection sections are arranged along the wavelength dispersion direction of the diffraction grating and output electric signals independently of each other.

2. The optical spectrum analyzer as claimed in claim 1 wherein each of said light detection sections outputs the electric signal to said signal processing section via different wiring.

3. The optical spectrum analyzer as claimed in claim 1 wherein the plurality of light detection sections are a photodiode array formed on the same substrate.

4. The optical spectrum analyzer as claimed in claim 2 wherein the plurality of light detection sections are a photodiode array formed on the same substrate.

5. The optical spectrum analyzer as claimed in claim 1 wherein said deflection section is any of an acousto-optic deflector, a polygon mirror, a galvanoscanner, or an MEMS mirror.

6. The optical spectrum analyzer as claimed in claim 1 wherein said optical spectrum analyzer is of double-path type for twice dispersing the measured light into a spectrum.
